(19) United States
(12) Patent Application Publication
(10) Pub. No.: US 2002/0091790 A1
(43) Pub. Date: Jul. 11, 2002

(54) INTERNET RADIO AND INDEXING SYSTEM FOR MANAGING AUDIO CONTENT PROVIDERS AND SUBSCRIBERS

(75) Inventor: Scott A Cubley, Houston, Texas (US)

Correspondence Address: Jonathan M. Harris, Conley, Rose & Tayon, P.C., P.O. Box 3267, Houston, Texas, 77253-3267, US, jharris@crtlaw.com, (713) 238-8000, (713) 238-8008

(73) Assignee: Synchton Incorporated, Houston, 77059 (US)

(21) Appl. No.: 09/665,082

(22) Filed: Sep. 20, 2000

(51) Int. Cl. G06F 15/16

(52) U.S. Cl. 709/217; 709/231

(57) ABSTRACT

### Abstract of Disclosure

An on-line audio indexing network facilitates listeners to communicate with on-line audio content providers. Preferably, the on-line audio content providers are Internet audio broadcasters and the on-line audio indexing network, listeners and audio content providers are coupled via the Internet. To listen to audio broadcasts, the listeners communicate with the on-line audio content providers and the indexing network via audio appliances, rather than standard personal computers.

### Cross Reference to Related Applications

Not applicable.

### Federal Research Statement

Not applicable.

### Background of Invention

### Field of the Invention

The present invention generally relates to an Internet radio and on-line indexing system. More particularly, the indexing system relates to managing audio content providers and listeners (or subscribers). More particularly, the Internet radio relates to an audio appliance that has Internet access to permit a subscriber to listen to one or more audio broadcasts available on the Internet using the indexing system.

### Background of the Invention

Conventional radio broadcasting involves each radio station transmitting through the air waves its broadcast signal on an assigned carrier frequency. Such radio broadcasting has been widely available for many decades and is highly reliable. However, conventional radio broadcasting has various shortcomings. For instance, each radio generally can only be tuned to the radio stations located in the general vicinity of the radio. This is particularly true, for example, for FM radio stations. This shortcoming is a result of FM radio signals having only a limited broadcast range. Further, many areas of the world are such that radio reception is impossible or at least very poor. This may result from mountains blocking radio transmissions or isolated areas that simply are not close enough to the radio transmitters to be able to receive a sufficiently strong signal. Lastly, radio stations lack a direct mechanism for measuring listeners. Most for-profit radio stations generate income through the sale of audio advertisements. The fees paid by advertisers for these advertisements are dependent upon the size and composition of the listening audience. Without a direct mechanism for measuring listeners, radio stations are forced to rely upon statistical sampling and extrapolation to estimate the radio station"s listener habits.

The Internet advantageously provides a communication infrastructure that can be used to solve these problems. Internet-based audio broadcasters are springing up all over the world. Each Internet audio broadcaster"s audio stream is transmitted over the Internet to Internet-accessible computers that access that the broadcaster"s web site. Many options are available for computers today to provide the computer the ability to listen to music, voice, or any other types of audio content. Many computers are available with speakers and various software companies provide the software, such as Microsoft"s™ Windows Media™ Player or Real Network"s Real Player™, useful to enable the computer to play music transmitted by the audio broadcaster.

The ability to listen to streaming audio on a computer from Internet-based audio broadcasters is gaining popularity, but it also is not problem-free. For example, the current methodology for listening to Internet audio broadcasts generally requires a personal computer (PC) connected to the Internet. The requirement for a PC leaves those people that would like to listen to Internet audio content, but do not have a PC, unable to take advantage of Internet audio broadcast technology. Additionally, listening to Internet audio broadcasts requires the PC user to be near the computer. If the user wishes to listen to Internet audio broadcasts in multiple rooms of the house, the user might need a different computer in each room, which would generally be cost prohibitive for many people. Also, processing resources on the PC must be shared with the audio software, thereby limiting resources available to the other computer software applications. Further, other application software running on the PC while the audio application is playing an Internet audio broadcast may limit resources available to the audio software thereby interrupting the continuous play of the audio selection. Additionally, it may be a distraction to one person wishing to use the computer to do work, while another person wishes simply to listen to an Internet audio broadcast via the same computer. Finally, the number of Internet audio broadcasts has become very large and is likely to grow even larger. This presents a tremendous burden for users to be able to find and select the types of audio broadcasts to which they want to listen.

Accordingly, a device and system is needed that solves some or all of these problems. Despite the advantage such a device and system would provide, no such solution is known to exist today.

### Summary of Invention

The problems noted above are solved in large part by an on-line audio indexing network that facilitates communication between listeners and on-line audio content providers. Preferably, the on-line audio content providers are Internet audio broadcasters and the on-line audio indexing network, listeners and audio content providers are coupled via the Internet. To listen to audio broadcasts, the listeners communicate with the on-line audio content providers and the indexing network via network audio appliances, rather than standard personal computers.

The on-line audio indexing network permits the Internet audio broadcasters to register their broadcasts by providing demographic information, a network address (e.g., a uniform resources locator or URL), and descriptive text describing the type of programming transmitted by the audio broadcaster at the designated URL. The on-line audio indexing network assigns the audio broadcast at the designated URL a unique audio broadcast identification number. The broadcast information and the identification number are stored by the on-line indexing network in a content provider database.

Listeners may register with the on-line indexing network using a standard personal computer with a web browser. To register, the listener enters demographic information, an electronic mail address, and other listener specific information. The on-line audio indexing network assigns the listener a unique listener identification number. During the registration process, or afterwards, the listener registers each network audio appliance operated by the listener by entering the network audio appliance"s unique identification number. The unique network audio appliance identification number is assigned and programmed into the network audio appliance by the manufacturer of the network audio appliance, is assigned by the manufacturer of the network audio appliance and programmed into the network audio appliance by the listener, or it is assigned by the on-line audio indexing network during the network audio appliance registration process and programmed into the network audio appliance by the listener.

The on-line indexing network assigns each registered network audio appliance a default audio content profile. The audio content profile comprises a categorized subset of audio broadcasts registered by audio broadcasters in the content provider database. The listener may customize an audio content profile during the registration process or at some other time using a personal computer and web browser. The listener information, the listener identification number, the listener"s list of network audio appliance identification numbers and the network audio appliance content profiles are stored in a listener database in the on-line indexing network.

If the listener has obtained a listener identification number by registering with the on-line audio indexing network, the listener programs his or her unique listener identification number into the network audio appliance. Otherwise, the listener is assigned a unique anonymous listener identification number the first time that they connect to the on-line audio indexing network with the network audio appliance. Upon power on, the audio appliance accesses the on-line audio indexing network and establishes communication with the network. A valid network audio appliance identification number is required for connection to the network. Once the network audio appliance has been authenticated, the network downloads into the network audio appliance the appliance"s audio content profile previously created by the listener. If the listener has not created an appliance content profile for the network audio appliance, a default appliance content profile is assigned to and downloaded by the network audio appliance. Using controls on the appliance, the listener can select one of the audio broadcasts listed in the appliance content profile to play.

These and other features will be explained in the following detailed description. The on-line audio indexing network and network audio appliances permit listeners easy access to and management of a wide selection of audio broadcasts using a simplified network audio appliance user interface. Further, other than the optional registration process and possible updates, the listener can select and listen to Internet audio broadcasts without a conventional personal computer. Management and control of the process of searching for and selecting Internet audio broadcasts have been effectively centralized by an on-line indexing network. Other benefits will become apparent upon reviewing the following disclosure.

### Brief Description of Drawings

For a detailed description of the preferred embodiments of the invention, reference will now be made to the accompanying drawings in which:

Figure 1 shows an on-line indexing network in accordance with the preferred embodiment of the invention;

Figure 2 shows a perspective view of one embodiment of a network audio appliance;

Figure 3 shows a perspective view of another embodiment of a network audio appliance;

Figure 4 shows a block diagram of the network audio appliance;

Figures 5 and 6 show portions of information stored in the on-line indexing system to permit listeners of the network to easily find and connect to Internet audio content providers;

Figure 7 shows an exemplary embodiment of a power on sequence for the network audio appliance;

Figure 8 shows an exemplary embodiment of a play mode sequence for the network audio appliance;

Figure 9 shows an exemplary embodiment of a wait mode sequence for the network audio appliance; and

Figure 10 shows an exemplary embodiment of a bookmark mode sequence for the network audio appliance.

### Detailed Description

### Notation and Nomenclature

Certain terms are used throughout the following description and claims to refer to particular system components. As one skilled in the art will appreciate, various companies may refer to a component by different names. This document does not intend to distinguish between components that differ in name but not function. In the following discussion and in the claims, the terms including and comprising are used in an open-ended fashion, and thus should be interpreted to mean including, but not limited to…. Also, the term couple or couples is intended to mean either an indirect or direct electrical connection. Thus, if a first device couples to a second device, that connection may be through a direct electrical connection, or through an indirect electrical connection via other devices and connections.

The following description focuses on an on-line audio system, but the system could be adapted to other types of media, such as video and audio/video (e.g., television programming), and other Internet appliances that could benefit from the management of a wide array of content using an on-line indexing system and a simplified Internet appliance user interface. Specifically, the term media refers to audio, video, a combination of audio and video or any other type of multimedia signals or information.

### Detailed Description of the Preferred Embodiments

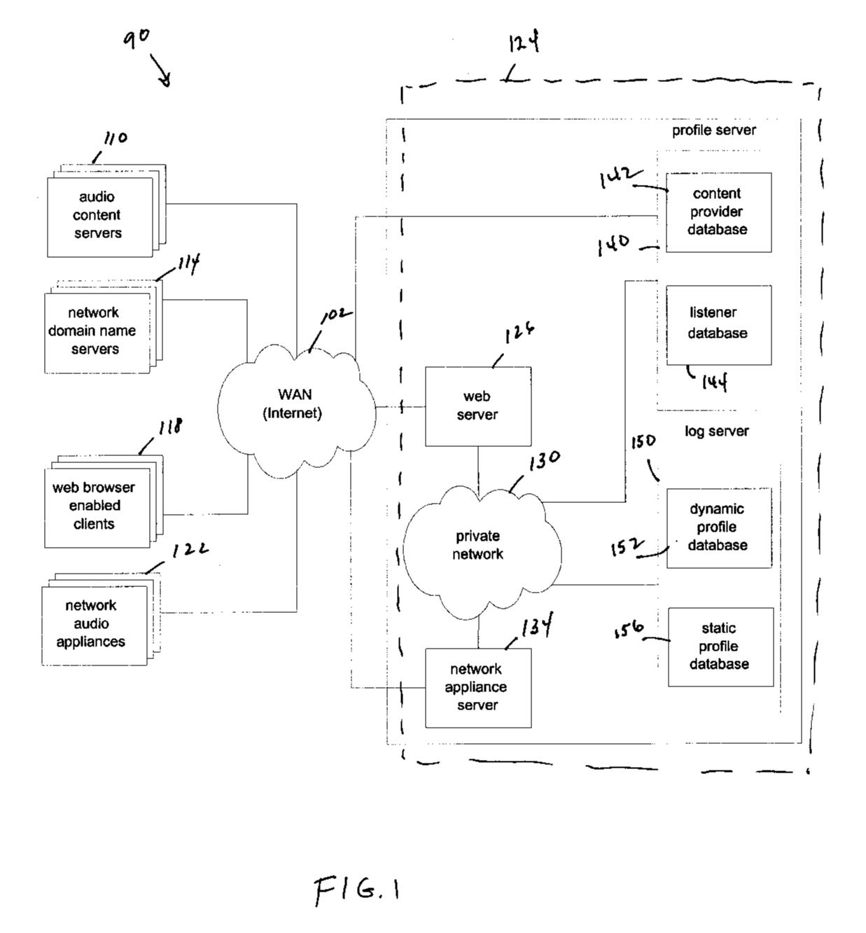

Referring now to Figure 1, an Internet-based, audio system 90 in accordance with the preferred embodiment is shown. The indexing network 90 preferably includes audio content providers 110, network domain name servers 114, computers 118 with web browser software, network audio appliances 122, a wide area network (WAN) 102, such as the Internet, and an onindexing network 124. The indexing network 124 preferably includes a web server 126, a private network 130, a network appliance server 134, a profile server 140 and a log server 150. It should be understood that audio system 90 shown is only one of numerous possible configurations, and the claims which follow should not be limited to the specific embodiment shown unless otherwise specified in the claims themselves.

The audio content providers 110 include one or more, and typically many, Internet-based audio broadcasters. Each Internet audio broadcaster generally has its own unique uniform resource locator (URL) and corresponding Internet Protocol (IP) address. The URL is typically in the form of www.radiostationname.com and the IP address is typically in the form of 123.123.123.123. Because IP addresses can be difficult to remember and are subject to change, an easier to remember URL is associated with each IP address. As is commonly known, the network domain name servers (DNSs) 114 receive URL look-up requests from entities on the Internet, match each URL to its associated IP address and return the IP address back to the entity that initiated the inquiry. The entity can then access the IP address directly.

The computers 118 comprise any suitable type of PC that have Internet access with web browser software. As described below, in the preferred embodiment of the invention the computers 118 are used to allow Internet audio broadcasters to register their broadcasts and to allow the listeners to establish listener profiles, register network audio appliances and establish and modify network appliance content profiles. The network audio appliances 122 are the devices through which a listener can select from and listen to audio selections in the network appliance content profile. The audio content providers 110, the DNSs 114, the computers 118, and the network audio appliances 122 preferably are all connected to the Internet 102 which, alternatively, could be any type of wide area network, now known or later developed.

The profile server 140 in the on-line, indexing network 124 connects to the Internet 102 and preferably contains a content provider database 142 and a listener database 144. The log server 150 includes a dynamic profile database 152 and a static profile database and connects to the private network 130. All four of these databases 142, 144, 152, and 156 will be described below. Preferably, the web server 126 and network appliance server 134 also connect to the private network 130.

Generally, audio content providers 110 register their audio content with the audio indexing system 124 by providing content provider-specific information to the network"s web server 126 which stores such information in the content provider database 142. Similarly, listeners that wish to establish on-line profiles within the indexing network 124 also use a computer 118 to store user-specific information in the listener database 144. Once audio content providers 110 and listener network audio appliances 122 are registered with the indexing network 124, the listeners can use their network audio appliances 122 to listen to streaming audio from the audio content providers 110. The indexing network 124 facilitates the registration process and makes it easy for listeners to find and listen to the audio broadcast they desire. Further, once listeners register themselves with the indexing network 124, the listeners advantageously can listen to Internet audio content without having to use a PC 118, thereby solving many of the problems noted above. The combination of the audio content providers 110 and the indexing network 124 permits subscribers to use their audio appliances 122 in a manner similar to a conventional radio. For example, as will be described in more detail below, a listener can simply push a button on the audio appliance 122 to automatically switch between Internet audio broadcasts.

The term listener is not intended to connote payment for a service. Thus, a listener can subscribe to the on-line indexing network 124 with or without paying a fee. Whether a fee is required by listeners, and content providers for that matter, is entirely up to the operator of the indexing network 124.

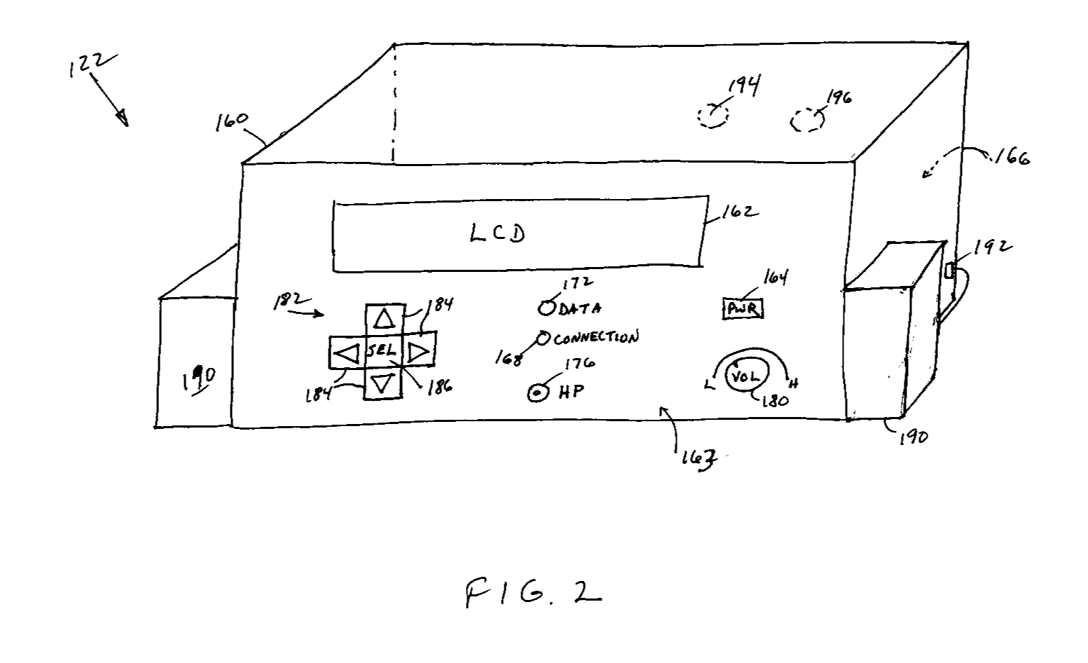

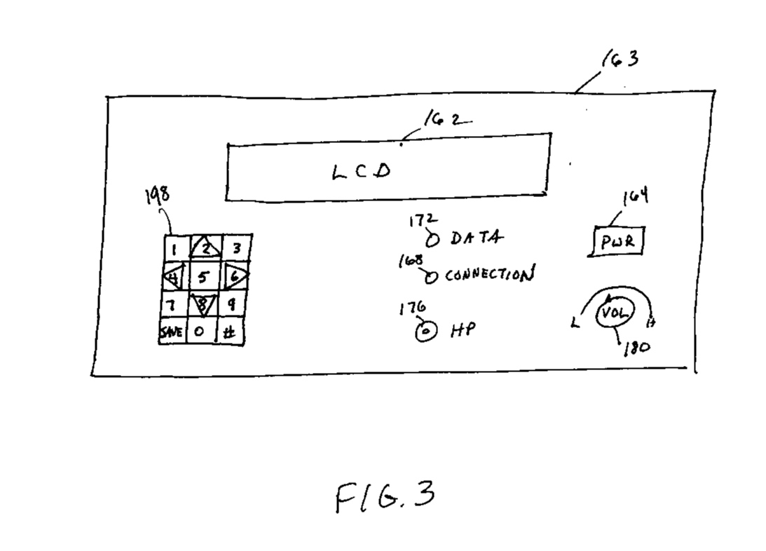

Referring now to Figure 2, a perspective view of the network audio appliance 122 is shown. The network audio appliance includes an enclosure 160 generally having six sides. The front face 163 includes various displays and controls as shown. The controls include a power button 164 to turn the unit on and off, a volume control 180 to adjust the volume of the audio signal, and a key pad 182 to select from available audio broadcasts and to configure the appliance. The key pad 182 preferably includes up, down, left and right arrow keys 184 and a select button 186. The displays include a liquid crystal display (LCD) display 162, a network light emitting diode (LED) 168 to indicate whether the appliance is connected to the network 102, and a data LED 172 to indicate when the unit is receiving or transmitting data. A connector 176 also is provided for connecting to a headphone set (not shown). Referring briefly to Figure 3, an alternative embodiment of front panel 163 is shown. The main difference is that the arrow keypad 182 has been replaced with a 10-digit keypad 198 that includes a button for each of the numerals 0-9, four arrow keys, a save button and an enter button (which could be the #-key or other button not shown). The keypad 198 in Figure 3 is similarly used to select from available audio broadcasts.

Referring again to Figure 2, the network audio appliance 122 also includes a pair of speakers 190 connected to audio jacks 192 mounted on the enclosure 160 at a convenient location. The rear face 166 of the network audio appliance 122 preferably includes a power connector 194 and at least one communication connector 196. The power connector 194 is used to plug the appliance 122 into a 120 VAC outlet (or other available voltage) for power. The communication connector 196 is used to couple the appliance 122 to the Internet 102. The communication connector 196 can be a standard RJ11 telephone connector for connection of an internal modem to a telephone line, an RJ45 connector for an Ethernet connection, or a Universal Serial Bus (USB) for connection to an external communication device. If desired, multiple network connectors can be provided. If the USB port is selected, other USB port compatible network connection methods, such as Ethernet or wireless interfaces, can be utilized. The appliance 122 can then be configured to connect to the Internet 102 via whatever type of network connection is present.

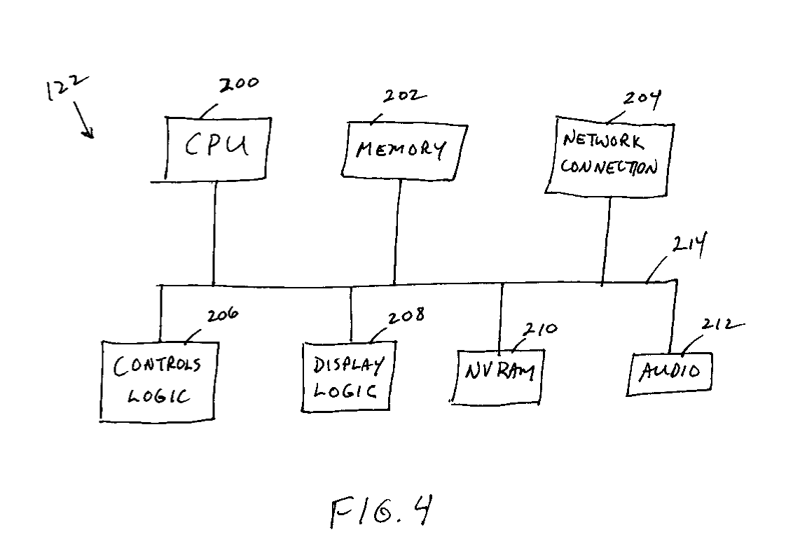

Figure 4 shows a preferred block diagram of the network audio appliance 122. As shown, the appliance includes a central processing unit (CPU) 200, a memory 202, a network connection logic 204 (e.g., a modem, network interface card and/or a USB port), controls logic 206 for interfacing to the controls shown on the front panel 162, display logic 208 for interfacing to the various displays and LEDs shown on the front panel, non-volatile memory 210, and an audio subsystem 212. The components shown are coupled together via a common bus 214, but numerous other interconnection topologies are also possible as would be known to those of ordinary skill in the art.

The CPU 200 preferably comprises any suitable type of programmable microprocessor or microcontroller. Alternatively, discrete digital control logic could be used instead of a microprocessor. The memory 202 preferably includes one or more dynamic random access memory (DRAM) devices or modules to provide temporary working memory for the CPU 200. The network connection logic 204 provides an interface to the network connector 196 and may include a modem, network interface card (NIC), a USB port or other suitable type of connection to connect to the Internet 102. Logic 206 and 208 may be separate pieces of digital logic or may be combined into one piece of logic as desired. These logic circuits detect and interpret signals from the various controls, such as volume control 180 and keypad 182 (or 198 in Figure 3), and provide signals to displays 162, 168, and 172. The volume control 180 may also be coupled to the control logic 206 or be connected to the audio subsystem 212 which provides the audio signal for either the speakers 190 or headphone jack 176. If headphones are plugged into jack 176, the audio signal preferably is provided to the headphone jack 176 and not to speakers 190. The non-volatile memory 210 preferably is used to store the firmware executed by CPU 200 as well as any other data that is used over and over. The non-volatile memory may be any type of fixed disk drive (e.g., a hard drive) or various types of solid-state storage devices.

At least one of the applications executed by the CPU 200 is software that permits the network audio appliance 122 to receive streaming audio over the wide area network. Such software is readily available and well-known to those of ordinary skill in the art. Further, if desired, the network audio appliance may include a commonly available decoder chip to receive and process the streaming audio signal.

Referring again to Figure 1, each owner/operator of a network audio appliance 122 preferably registers himself and his network audio appliances 122 with the network 124. The registration process preferably occurs using a PC 118 connected to the Internet 102 by accessing the indexing network"s web server 126 at a previously determined and known web site URL. The listener registration process includes providing the network 124 the listener"s name, address, phone number, email address and/or other demographic information. The listener is then assigned or permitted to choose a unique listener identification number. As such, each listener is assigned a unique listener identification number that permits the indexing network to individually track and manage each person"s interaction with the indexing network 124. The listener"s identification number, as well as the other identification numbers described herein, can be a combination of numerals, letters or other types of characters. The listener"s demographic information and identification number are stored in the listener database 144. The listener is also permitted to associate a unique audio appliance identification number for his audio appliance 122 with the listener"s unique identification number. This association is also stored in the listener database 144. The network 124 uses the network audio appliance identification number to grant a network audio appliance 122 access to the network 124 and to individually coordinate and communicate with each appliance 122.

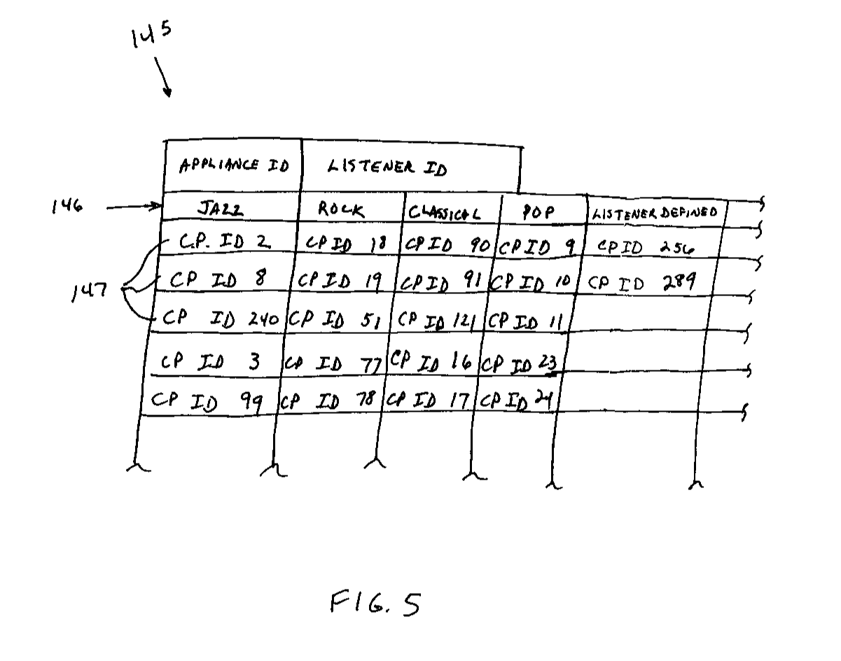

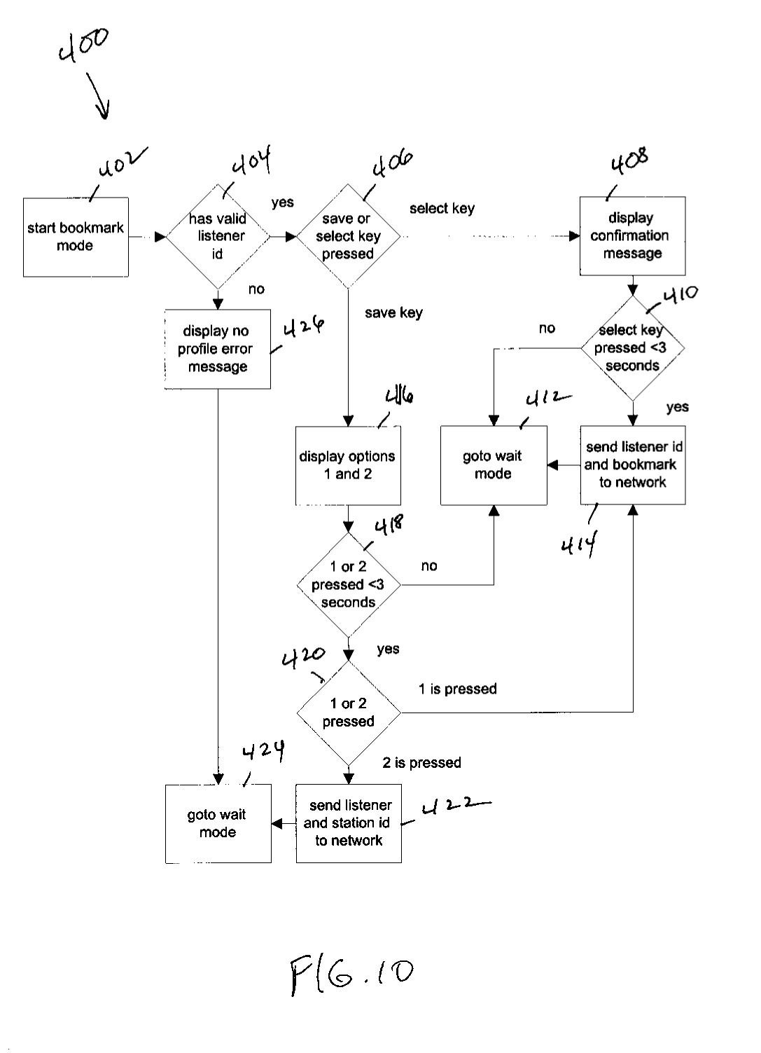

Referring now to Figures 1 and 5, once the listener identification number is assigned, the listener uses a PC 118 to create a network appliance content profile 145 which also is stored in listener database 144. The network appliance content profile 145 comprises a matrix or table of content provider identification numbers 147 preferably organized according to various categories 146 of music (e.g., Jazz, Rock, Classical, Pop, etc.) as shown, although the organization can be varied as desired. The number of categories 146 can be any number desired and the number of content provider identification numbers per category also can be set as desired. For example, a network appliance content profile 145 may be a 7 x 9 matrix having 7 categories of audio content and 9 possible content provider identification numbers for each category. The web server 126 offers the listener the complete list of registered audio broadcasts stored in the content provider database 142 with each registered audio broadcast having a unique content provider identification number. The listener chooses from the complete list those audio broadcasts the listener wishes to make available for listening via their network audio appliance 122. The complete list is stored in the content provider database 142. The complete list may comprise tens or hundreds of thousands or more of audio broadcasts organized in any suitable manner such as by type of music and is searchable by the listener using a PC 118. The network audio appliance content profile 145 is created by a listener for a particular network audio appliance identification number and also is stored in the listener database 144. If the listener has more than one network audio appliance, the listener can create a separate (or the same) network audio appliance profile 145 for each such appliance. One category within the network audio appliance content profile, the local presets category, is reserved for storing content provider identification numbers that have been flagged for saving by the operator of the network audio appliance. This functionality is detailed in Figure 10 and explained below in the discussion of the network audio appliance"s bookmark mode.

After the network audio appliance content profile 145 is created by the listener, the profile preferably is downloaded from the network 124 to the appliance 122 the first time the appliance 122 connects to the network or subsequently, if desired. Once downloaded, the listener can use the keypad 182 or 198 to scroll through the various choices in the matrix. For example, the subscriber can press the up/down/left/right arrow keys to move accordingly through the matrix to select a desired audio broadcast to play.

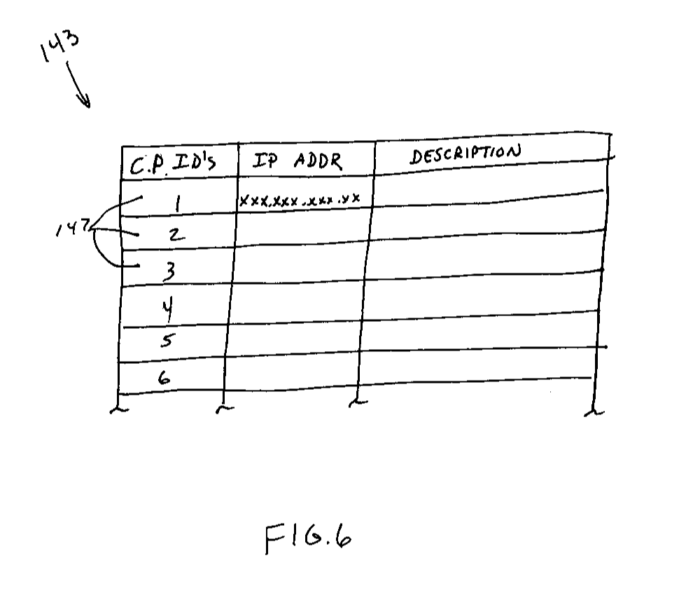

Each of the audio content providers 110 also preferably register its audio broadcasts with the on-line indexing network 124. Each audio content provider 110 preferably provides demographic information for the registrant (e.g., name, physical address, email address, etc.). The content provider 110 then enters a URL and/or an IP address and classification information for its audio broadcast . If the registrant has or operates more than one audio broadcast, the registrant can enter a URL and/or IP address for each such audio broadcast. Each audio broadcast is assigned a unique content provider identification number and is added to the content provider database 142. As shown in Figure 6, each entry in the content provider database 142 corresponds to a content provider"s audio broadcast and includes a unique content provider identification number, a URL and, if desired, descriptive text describing the type of music provided by the audio broadcaster. In accordance with the preferred embodiment of the invention, content provider identification numbers are stored in the audio appliance content profiles 145 (Figure 5) rather than content provider"s URL or IP address, although if desired the URL or IP address could be used. Although acceptable, the station"s URL is not the most preferred identifier to use in the audio appliance content profiles 145 because of the large number of characters included in many URLs, the resulting burden on storage that would be required to store URLs in the various appliance profiles 145 and the burden of entering a lengthy alphanumeric URL using a simplified non-keyboard user interface. Although acceptable, the IP addresses are not the most preferred type of station identifier because a stations" IP address may change, thereby causing a management burden to update all of the appliance profiles 145 that have a changed IP address. The content provider database 142 efficiently permits the indexing system 124 to associate content provider identification numbers to URLs and IP addresses.

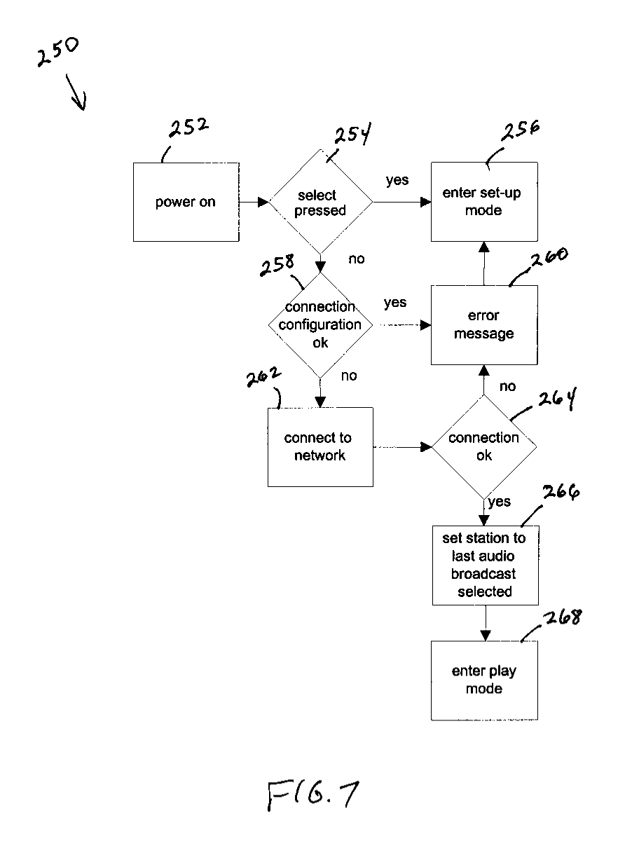

The use of the network audio appliance 122 and the indexing system 124 in accordance with a preferred embodiment of the invention will now be described with reference to the flow charts of Figures 7-10. These flow charts depict actions that software stored in the audio appliance"s non-volatile memory 210 (Figure 4) and executed by CPU 200 perform. One of ordinary skill could readily write the software given the functions it performs as shown in Figures 7-10. In explaining the operation of the network audio appliance 122, it is also necessary to explain the operation of the indexing network 124. Accordingly, the operation of the network 124 will become apparent upon reviewing how the appliance 122 works.

Referring first to Figure 7 in conjunction with Figure 2, a power on sequence 250 is shown for the audio appliance 122. In step 252, a listener presses the power button 164 (Figures 2 and 3) to begin the power on sequence. In step 254, the appliance"s CPU 200 determines whether the select button 186 (Figure 2) or the save button (Figure 3) has been pressed while the unit"s power is cycled on. If the listener holds down the select button 186 or the save button (Figure 3) while the power button 164 is pressed, the appliance 122 will enter a set-up mode in step 256. In the set-up mode, the listener can configure the device as desired. For example, the listener can configure one or more of the following aspects of device operation:(1) Display or update listener identification number;(2) Modify communication settings (select network access method, each method has own type of settings, examples of information to set include DHCP (Y/N), device IP address, DNS IP address, gateway or proxy IP address, ISP telephone number, tone or pulse dialing, ISP logon-id, and ISP password);(3) Select display language (e.g., English, Spanish, German, French, Portuguese);(4) Reset unit to default factory settings;(5) Display or update audio appliance identification number;(6) Enable or disable clock display (if enabled will be updated based upon user profile on web site--listener profile will specify or determine which timezone to use, if user profile does not exist then user would want to disable this function because time would be wrong--otherwise time information is available via web site and third party time service); and(7) Display or update network server domain names (e.g., URL for three network appliance servers, primary and two back-ups, that audio appliance will contact for authentication).

If the front panel 163 of Figure 2 is used, which does not include a 10-digit keypad, any suitable technique for entering alphanumeric information can be used. For example, the listener can use the up and down arrow keys to select each numeral in a numeric identifier, similar to setting a lock on a combination padlock. Once a numeral is selected, the listener presses the SEL button 186 to set that digit and move on to the next character. Preferably, purely numeric information is used to facilitate data entry through the relatively limited user interface provided by the network audio appliance, particularly the embodiment of Figure 2. For example, the URL for the network appliance server 134 should be a numeric-based URL such as 1234567.com. Further, the network audio appliance 122 can automatically append any necessary information such as the .com in the preceding example. In this way, the listener only has to enter the numeric portion of the URL during set-up.

Additionally, the ability to change the location of the network server through the set-up mode preferably is a feature that can enabled and disabled by network 124 or by during manufacturing of the appliance itself by the manufacturer.

If the select button 186 is not pressed during power on, the appliance"s software does not transition to set-up mode and instead determines whether the connection configuration is acceptable in step 258. This step is accomplished by comparing the connection configuration information programmed into the appliance 122 to the type of network connections and hardware the appliance has available. For example, if the configuration connection is set for connection to the Internet via a dial-up modem, decision step 258 determines whether a phone line is connected to network connector 196 and a dial tone is present on the line. If the connection configuration does not match the connections or hardware, then an error message is shown on LCD display 162 to indicate the error condition to the listener and the set-up mode 256 is entered permitting the listener to try to correct the problem.

If, on the other hand, the connection configuration does match the hardware, the appliance 122 attempts to connect to the Internet in step 262. If this connection is not successful, as determined by decision step 264, then an error message is shown on the LCD display (step 260) and set-up mode is entered (step 256) to permit the listener an opportunity to correct the problem. If the connection is successful, then in step 266 the appliance 122 sets the current selected audio broadcast to the audio broadcast to which the listener last listened. Finally, play mode is entered in step 268 and streaming audio from the selected station is played through the appliance"s speakers 190 or headphones if attached.

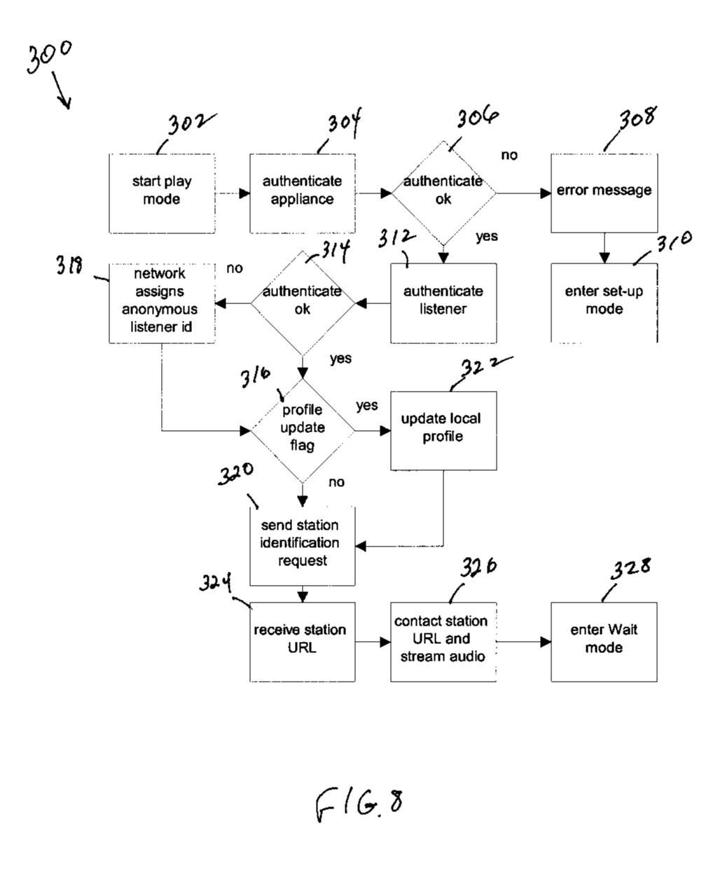

Referring now to Figure 8, an exemplary play mode sequence 300 is shown. Play mode begins in step 302. In step 304, the appliance 122 is authenticated. This step can be performed in any suitable manner. For example, every network audio appliance 122 that can connect to the indexing network 124 preferably has a unique network appliance identification number as described above. As noted above, the network appliance identification number can be preprogrammed into the appliance or assigned during the subscriber registration process and loaded into the appliance via the keypad 182, 198. The network appliance identification number serves to control access to the network 124 and informs the network 124 of the type of appliance that is accessing the network. An appliance 122 preferably cannot access the network without a valid network appliance identification number. If an invalid network appliance identification number is received by the network 124 as determined in step 306, the appliance 122 will not be permitted access to the network 124 and the appliance will display an error message on LCD display 162 in step 308. At that point, the setup mode will be entered in step 310 to permit the listener to enter a valid network appliance identification number.

Once a valid network appliance identification number is transmitted to the network 124 and verified as valid in step 306, the appliance 122 will transmit a listener identification number to the network 124. In step 312, the network 124 preferably determines whether the listener identification number is valid by comparing the transmitted values to stored values in the listener database 144. In the event the listener identification number is not present in the listener profile database 144 or is invalid, as determined in step 314, the network 124 will assign the appliance 122 an anonymous listener identification number (step 318) which is then stored in memory 210 of the appliance 122. Once a listener identity has been established, the appliance 122 will check to see if the local network audio appliance content profile (i.e., the appliance profile matrix 145 stored in non-volatile memory 210 in the appliance 122), needs to be updated with the on-line profile 145. This step is beneficial if the listener has changed an existing on-line audio appliance content profile 145 (Figure 5) that has been previously downloaded to the appliance"s non-volatile memory 210 or if no content profile 145 is present in memory 210. This decision step can be performed in any suitable manner. For example, if the listener changes his audio appliance content profile 145 on-line using a PC 118, the update will cause an update flag to become asserted by the network 124 for that particular audio appliance. If the update flag is determined to be asserted (step 316), the network 124 will download the updated content profile in step 322 to the appliance 122 which then overwrites the existing (i.e., outdated) content profile stored in its non-volatile memory 210. If no content profile is stored in memory 210, the appliance sends a message to the network 124 requesting it to download the on-line content profile. If, on the other hand, the listener has used keypad 182 or 198 to change the station matrix stored locally in the appliance 122 and not the on-line matrix, the listener will be prompted in step 322 to upload the local matrix to the network 124. Once uploaded, the network 124 stores the new matrix in listener database 144.

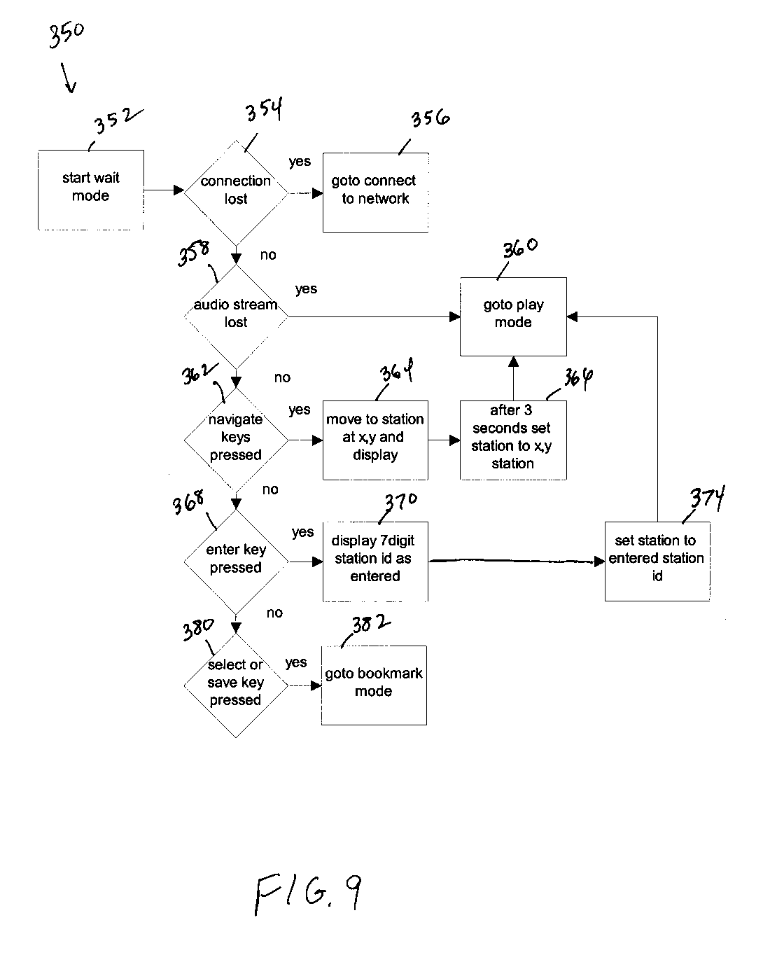

In step 320, the network audio appliance 122 transmits a content provider identification number request to the network 124. The request may simply be the last audio broadcast played by the appliance when it was last powered off. The network 124 uses the transmitted content provider identification number to retrieve from the content provider database 142 and 143 (Figure 6) the IP address of the requested audio broadcast (step 324). The appliance 122 then accesses the desired audio broadcast provided by the audio content providers 110 over the Internet using the IP address provided by the audio indexing network 124 and streaming audio begins to be played through the appliance in step 326. Alternatively, the content database 143 may include URLs, not IP addresses. In this case the network 124 uses the transmitted content provider identification number to retrieve from the content provider database 142 and 143 (Figure 6) the URL of the requested audio broadcast. With this alternative, the network audio appliance 122, will first contact a designated domain name server 144 to resolve the network 124 supplied URL into an IP address before accessing the desired audio broadcast supplied by the audio content providers 110. If desired, the descriptive text associated with the selected audio broadcast (Figure 6) can be shown on LCD display 162. Further, the audio content providers 110 also can transmit other information, such as the particular selection or song being played, for display on LCD display 162. In step 328, while the audio signal is playing through speakers 190 or headphones, the appliance 122 preferably enters the wait mode which is described below with respect to Figure 9.

Referring now to Figure 9, the firmware in the network audio appliance 122 preferably performs the actions shown. After entering the wait mode in step 352, the appliance preferably continuously checks the connection (step 354), the audio stream (step 358), whether someone has pressed the arrow keys on the keypads (step 362), whether someone has pressed the enter key on display 198 (step 368), and whether someone has pressed the select button 186 or display 182 or save key on display 198 (step 380). If neither the connection nor the audio stream have not been lost and the arrow keys, the enter key, the select key or the save key have not been pressed, the audio appliance"s firmware loops back and repeats its check of these conditions.

If, however, the network connection has been lost, the appliance in step 356 will attempt to reconnect to the network 124. If the audio stream has been lost, the appliance 122 transitions back to the play mode (Figure 8) in step 360 to permit the appliance to establish a new connection with a audio content provider 110. If an arrow key is pressed, the firmware (step 364) adjusts internal software pointers to point to a new entry in the locally stored audio appliance content profile 145. Thus, the up and down arrow keys scroll up or down through a single column (i.e., type of music). If the right and left arrow keys are pressed, the firmware moves from one column of the matrix to the next preferably remaining at the same row. In step 366, the appliance will then wait approximately 3 seconds and then, if the subscriber has not pressed another arrow key, set the audio broadcast to the content provider identification number pointed to in the local appliance content profile. This is accomplished by transmitting the new content provider identification number from the local content profile 145 to the network 124 which then reports back to the appliance 122 the IP address or alternatively the URL associated with newly requested broadcast.

Referring still to Figure 9, using an appliance 122 with a front panel 163 as shown in Figure 3, after having pressed the enter key in step 368 on keypad 198, the subscriber can type in the unique content provider identification number for any desired audio broadcast, even an audio broadcast that is not included in the local or on-line appliance profiles 145. After the new content provider identification number has been entered, step 368, the appliance 122 preferably displays the newly entered content provider identification number on its LCD display 162 and in step 374 sets the requested audio broadcast to the newly entered content provider identification number. Then, the appliance"s firmware transitions to the play mode 360 as shown to connect to that audio broadcast. If desired, if more than approximately 3 seconds have passed since the last numeric character has been pressed, the LCD display 162 is cleared and program control flows back to the connection decision step 354. This avoids the necessity of having a clear or backspace button on the keypad. Finally, if the select button 186 or save key on keypad 198 (described below) is pressed in step 380, the appliance"s firmware transitions to the bookmark mode 382 to permit the listener the ability to record local audio appliance audio broadcast information in the network 124 listener database 144 and, with keypad 198, mark audio broadcasts for addition to audio appliance content profiles.

Referring now Figure 10, an exemplary bookmark mode is shown. The bookmark mode can be entered into in any one of a variety of ways depending on the keypad used with the appliance. For instance, using the keypad 182 of the front panel 163 shown in Figure 2, the bookmark mode can be accessed by entering the select button 185 twice. Alternatively, the bookmark mode can be entered using the keypad 198 of Figure 3 by pressing the save key followed by the 1 key. Figure 10 shows what happens in either embodiment. The audio appliance 122 preferably will not enter the bookmark mode unless a valid listener identification number exists on the indexing network 124 as determined in step 404. If the listener identification number is not valid or an anonymous listener identification number has been assigned, an error message is displayed on LCD 162 and the wait mode 424 (Figure 9) is entered.

If keypad 182 of the front panel 163 shown in Figure 2 is used to enter the bookmark mode, a confirmation message is displayed on LCD display 162 to confirm that the select button has been pressed. Then, if the select button again is pressed in less than approximately three seconds (step 410), the content provider identification number is transmitted in step 414 to the indexing network 124 along with the listener"s identification number. If the select button is not pressed within the predetermined time, the wait mode is entered in step 412.

In response to receiving the content provider identification number, the indexing network 124 preferably lists the station, artist, album and program for the selection that is playing in the listener database 144 (Figure 1). While on-line with a web-browser PC 118, the subscriber can download, print, or view his or her bookmark selections.

Alternatively, if keypad 198 on Figure 3 is used, once the save key is pressed, the listener has two options which are shown on display 162 in step 416. The first option, selected by pressing the number 1 on the keypad, permits the subscriber to bookmark the program (as described above). Thus, if the subscriber presses 1 (detected in step 420), the listener ID and bookmark information are transmitted to network 124 for storage in the listener database 144. If the listener presses the number 2, the second option, the current content provider identification number and the listener identification number are transmitted to the network 124 and the content provider identification number is appended to the local presets category (described above) of the network audio appliance content profile on a first-in-first-out FIFO basis. If the number of local presets exceeds the capacity of the local presets column then preferably the oldest entry in the local presets column will be displaced by the newly appended entry. The updated network audio appliance content profile is then downloaded from the network to the network audio appliance the next time the network audio appliance logs on-to the network 124 in step 322 in Figure 8.

One of the features of the audio system 90 is the ability to collect and maintain information on which listeners are choosing which audio broadcasts and which audio broadcasts have been selected by which listeners for their network audio appliance content profiles. As the appliances connect to the network 124 and request URLs or IP addresses for a given content provider identification number, this request, the date and time of the request, the appliance identification number making the request and the listener identification number are logged into the dynamic profile database 152. This information can then be analyzed and used to provide useful feedback to the network"s audio content providers to help them adjust their programming to suit the needs and desires of the subscribers. The static profile database 156 is maintained by the indexing network 124 to analyze which subset of the content provider database each subscriber has chosen for their appliance profile 145 to download to their appliance 122. This static database is essentially a summary of the network audio appliance content profiles and preferably is compiled on a periodic basis.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

Claims

1.An on-line system that coordinates the transmission of audio signals between a plurality of audio content providers and a plurality of listeners, comprising:
a web server coupled to a wide area network;
a network appliance server coupled to said wide area network;
a private network coupled to said web server and said network appliance server;
a profile server coupled to said private network; and
said profile server including a content provider database including a plurality of entries with each entry pertaining to an on-line audio content provider and each entry includes a content provider identifier and an on-line address corresponding to the on-line audio content provider.

2.The on-line system of claim 1 wherein said profile server also includes a listener database containing a plurality of appliance profiles, each appliance profile having a plurality of entries with each entry containing a content provider identifier corresponding to an on-line audio content provider.

3.The on-line system of claim 2 wherein each appliance profile is programmable by a listener in communication with the on-line system.

4.The on-line system of claim 1 wherein said wide area network comprises the Internet.

5.The on-line system of claim 2 wherein each appliance profile is organized as a matrix of columns and rows and each column corresponds to a listener-defined type of audio and each column has a plurality of elements with each element corresponding to a content provider identifier associated with that column"s type of audio.

6.The on-line system of claim 1 wherein each of said plurality of audio content providers is an Internet audio broadcaster.

7.The on-line system of claim 1 wherein the on-line address is an IP address, and each of said plurality of audio content providers registers with said on-line system by providing its IP address to the on-line system and the on-line system generates a content provider identifier for the audio content provider and the IP address and the content provider identifier are stored in said content provider database.

8.The on-line system of claim 7 wherein each of said listeners registers with the on-line system by providing demographic information to the on-line system and the on-line system generates a listener identifier, and the demographic information and the listener identifier are stored in a listener profile database which is contained in the profile server.

9.The on-line system of claim 8 wherein the network appliance server receives a content provider identifier from a network audio appliance coupled to said wide area network and said network appliance server compares the content provider identifier received from the network audio appliances to content provider identifiers stored in the content provider database and if a match is found retrieves the corresponding IP address and transmits it to the network audio appliance.

10.The on-line system of claim 2 wherein network audio appliances can communicate with the on-line system to establish communications with the on-line audio content providers and a listener can update an appliance profile using a network audio appliance.

11.The on-line system of claim 10 wherein the system sets a flag upon updating an appliance profile and downloads said updated appliance profile to a network audio appliance during power on of said network audio appliance if said flag is set.

12.The on-line system of claim 1 further including a dynamic profile database in which information is logged, said information including content provider identifiers that have been accessed by listeners.

13.The on-line system of claim 1 further including a dynamic profile database in which information is logged, said information including identifiers associated with listeners that have accessed audio content providers through said on-line system.

14.The on-line system of claim 1 further including a dynamic profile database in which information is logged, said information including content provider identifiers that have been accessed by listeners and identifiers associated with listeners that have accessed audio content providers through said on-line system.

15.The on-line system of claim 1 further including a static database which is periodically updated with information summarizing network audio appliance profiles, said appliance profile having a plurality of entries with each entry containing a content provider identifier corresponding to an on-line audio content provider.

16.A method of indexing a plurality of on-line audio content providers to facilitate communication between a plurality of listeners and the plurality of on-line audio content providers, comprising:
(a)registering each on-line audio content provider into an on-line system;
(b)registering each listener into the on-line system; and
(c)generating an appliance profile of audio content providers for each listener corresponding to an audio appliance.

17.The method of claim 16 wherein the on-line audio content providers, on-line system and audio appliances are coupled together via the Internet.

18.The method of claim 16 wherein (a) includes providing demographic information and an on-line address associated with the on-line audio content providers.

19.The method of claim 16 wherein (a) also includes providing descriptive text associated with the on-line address, said text describes the type of audio programming provided by said on-line audio content provider.

20.The method of claim 16 wherein (b) includes providing demographic information.

21.The method of claim 20 wherein (b) also includes providing an appliance profile listing one or more audio content providers.

22.The method of claim 21 wherein (b) also includes providing one or more content provider identifiers associated with on or more audio content providers to the on-line system.

23.The method of claim 16 further including downloading an appliance profile from the on-line system to an appliance.

24.The method of claim 23 further including uploading the appliance profile from the audio appliance to the on-line system.

25.The method of claim 23 further including uploading the appliance profile from the appliance profile to the audio appliance if the appliance profile downloaded to the audio appliance from the on-line system has been modified by a subscriber.

26.A network audio appliance configured to couple to an on-line audio indexing network, said network audio appliance comprising:
a CPU;
volatile memory coupled to said CPU;
non-volatile memory coupled to said CPU;
a network interface coupled to said CPU; and
an input control device coupled to said CPU;
wherein said non-volatile memory stores an appliance profile downloaded from an on-line indexing network, said appliance profile containing a plurality of indices to a plurality of on-line audio content providers.

27.The audio appliance of claim 26 wherein said input control device can be used to select one of said plurality of indices.

28.The audio appliance of claim 26 wherein the selected index is transmitted through the network interface to the on-line indexing network.

29.The audio appliance of claim 28 wherein in response to receiving an on-line radio station address, the network interface establishes communication with the radio station address.

30.The audio appliance of claim 26 wherein the input control device can be used to change the downloaded appliance profile.

31.An on-line system that coordinates the transmission of media signals between a plurality of content providers and a plurality of subscribers to said on-line system, comprising:
a web server coupled to a wide area network;
a network appliance server coupled to said wide area network;
a profile server coupled to said private network; and
said profile server including a content provider database including a plurality of entries with each entry pertaining to an on-line content provider and each entry includes a content provider identifier and an on-line address corresponding to the on-line content provider.
